(19) United States
(12) Patent Application Publication
(10) Pub. No.: US 2007/0157680 A1
(43) Pub. Date: Jul. 12, 2007

(54) COMPUTER LOCK WITH LOCK CYLINDER AND CANAL

(75) Inventors: Germain DeMartinis, Northridge, CA (US); Douglas Toby Brown, Santee, CA (US)

Correspondence Address: SIERRA PATENT GROUP, LTD., 1657 Hwy 395, Suite 202, Minden, NV, 89423, US

(73) Assignee: ANNETTE, LLC, Novato, CA (US)

(21) Appl. No.: 11/530,343

(22) Filed: Sep. 8, 2006

Related U.S. Application Data
(60) Provisional application No. 60/716,564, filed on Sep. 12, 2005.
(60) Provisional application No. 60/715,652, filed on Sep. 9, 2005.

(51) Int. Cl. E05B 65/00

(52) U.S. Cl. 70/57

(57) ABSTRACT

A computer lock comprising: a body having a top end, a bottom end opposite top end, a front side, a back side opposite front side, a first side adjacent to front side, and a second side opposite first side; an opening formed in front side between top end and bottom end, the opening extending from front side and terminating at a position preceding back end; a canal connected to the opening and extending from an opening on first side to an opening on second side, wherein a cable may be passed through the opening in front side and into the canal, and the openings on both first side and second side are narrower than the canal; and a push-button locking cylinder comprising a pin that blocks the opening in front side when locking cylinder is engaged and leaves the opening in front side unobstructed when locking cylinder is disengaged.

### CROSS-REFERENCE TO RELATED APPLICATIONS

This application claims priority to U.S. Provisional Application Ser. No. 60/716,564, filed Sep. 12, 2005, which is hereby incorporated by reference as if set forth herein.

### BACKGROUND

The present invention relates to computer locks. More particularly, the present invention relates to a computer lock having a lock cylinder and a canal for security cables and peripheral cables or wires, such as those for a mouse, keyboard and monitor.

### SUMMARY

The present invention is a useful, novel, and unobvious computer lock that provides a complete physical security solution for computers.

In one aspect of the present invention, computer lock is provided comprising: a body having a top end, a bottom end opposite the top end, a front side, a back side opposite the front side, a first side adjacent to the front side, and a second side opposite the first side; an opening formed in the front side of the body between the top end and the bottom end, the opening extending from the front side and terminating at a position preceding the back end; a canal formed in the body and connected to the opening, the canal extending from an opening on the first side to an opening on the second side, wherein a cable may be passed through the opening in the front side and into the canal, and the opening on the first side and the opening on the second side are both narrower than the canal; and a push-button locking cylinder disposed in the body, the locking cylinder comprising a pin that blocks the opening in the front side when the locking cylinder is engaged and leaves the opening in the front side unobstructed when the locking cylinder is disengaged.

### DESCRIPTION OF THE DRAWINGS

FIG. 1 is a perspective view of an exemplary computer lock according to the present invention along with a computer;

FIG. 2 is a side view of an exemplary computer lock according to the present invention locked to a computer;

FIG. 3A is a top view of an exemplary computer lock according to the present invention;

FIG. 3B is a front view of an exemplary computer lock according to the present invention; and

FIG. 3C is another side view of an exemplary computer lock according to the present invention.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The present invention is a device for securing a computer against theft. This device also locks in place peripheral cables and wires for the securing of other office equipment, such as a mouse, keyboard and monitor, against theft.

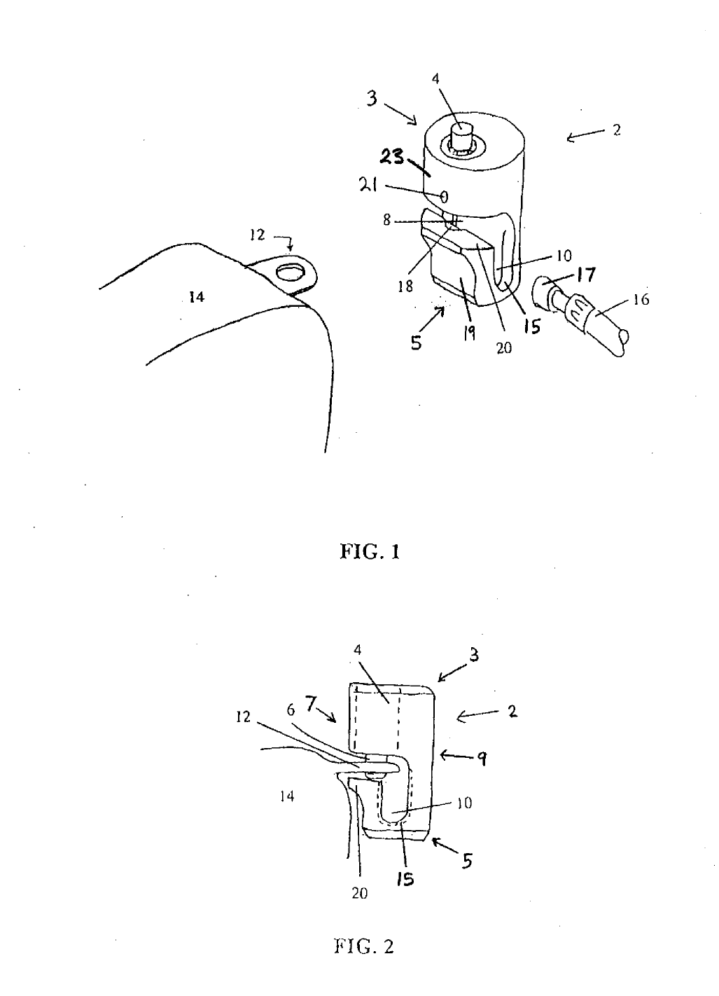

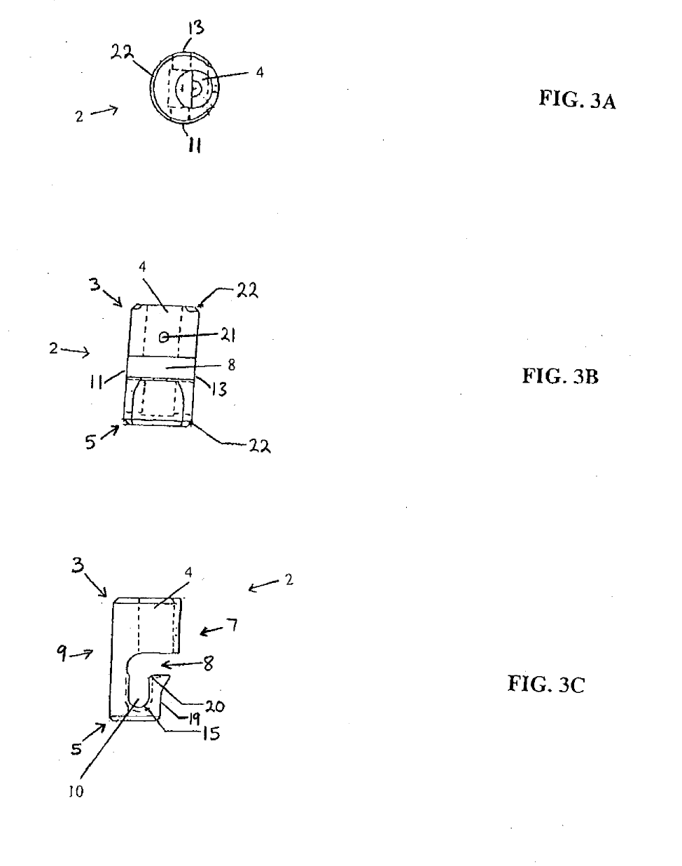

FIGS. 1-3C illustrate lock 2, with like components numbered alike. Lock 2 comprises a body having a locking, push-button cylinder 4, opening 8, lip 20, and canal 10. The body of lock 2 is preferably shaped to match the contours of computer chassis 14 and provide a tight fit when lock 2 is locked to built-in hasp or ring 12 on computer chassis 14. Lock 2 comprises a top end 3, a bottom end 5 opposite top end 3, a front side 7, a back side 9 opposite front side 7, a first side 11 adjacent front side 7, and a second side 13 opposite first side 11. The components of lock 2 are preferably formed from metal. However, a variety of different materials may be used to form lock 2.

Opening 8 is formed in front side 7 between top end 3 and bottom end 5 and preferably extends from first side 11 to second side 13. However, opening 8 terminates at a position preceding back side 9, preferably about halfway between front side 7 and back side 9. Opening 8 comprises a diameter large enough to receive security cable 16. Security cable 16 comprises an elongated body that terminates in cable end 17. Cable end 17 may be larger in diameter than the elongated body of security cable 16 or may be the same size. Security cable 16 and/or cable end 17 may pass through opening 8 towards back end 9. While FIGS. 1-3C illustrate opening 8 being formed about halfway between top end 3 and bottom end 5, it is contemplated that opening 8 may be positioned in other locations as well, such as closer to the top or the bottom of the body.

The formation of opening 8 creates a division on front side 7 between an upper portion 23 proximate top end 3 and a lower portion 19 proximate bottom end 5. The top of lower portion 19 forms a shelf or lip 20. The uppermost surface of lip 20 may be substantially planar. Lock cylinder 4 is preferably disposed on upper portion 23 proximate top end 3 and may be held in place by pin 21. Lock cylinder 4 may be any push-button lock cylinder known in the art that can be pushed into a locked position and unlocked using an unlocking mechanism such as a key. Lock cylinder 4 comprises locking pin 6. When lock cylinder 4 is disengaged, locking pin 6 maintains a position that leaves opening 8 unobstructed. Preferably, locking pin 6, or some other activation mechanism of lock cylinder 4, extends out of top end 3 when lock cylinder is disengaged (as seen in FIG. 1), thereby being accessible to the user for engagement. Built-in hasp or ring 12 on computer chassis 14 is placed in opening 8. When a user engages lock cylinder 4, locking pin 6 extends down and away from top end 3 towards lip 20 and passes through ring 12. Locking pin 6 preferably extends at least to the uppermost surface of lip 20. In a preferred embodiment, an indentation 18 may be formed in the uppermost surface of lip 20, preferably about halfway between first side 11 and second side 13. Indentation 18 is configured to receive locking pin 6, thereby allowing locking pin 6 to pass below the uppermost surface of lip 20 and completely block ring 12 from being removed from lock 2. Preferably, lock cylinder 4 is positioned closer to front side 7 than to back side 9 such that locking pin 6 is horizontally aligned with lip 20 and indentation 18.

As mentioned above, opening 8 is configured to allow cables, such as security cable 16 and peripheral cables (not shown), to pass through it. Opening 8 communicates with canal 10 so that cables may pass through opening 8 and be received by canal 10. Canal 10 is a channel formed in the body of lock 2, preferably extending downward into lower portion 19. Canal 10 is specifically designed to receive and secure security cable 16. Canal 10 is connected to opening 8 and extends from the interior of lock 2 to at least one of either first side 11 or second side 13, thereby forming a passageway from the interior of lock 2, through at least one of the sides out to the exterior of lock 2. One of the sides may be open, while the opposite side may be closed. However, in a preferred embodiment, canal 10 is open on both sides, extending all the way from first side 11 to second side 13. In this fashion, a passageway is formed that extends from the exterior of lock 2, through first side 11, to second side 13, out to the exterior of lock 2 on the opposite side from where the passageway began. This configuration allows cables to hang out from either side of lock 2. In a preferred embodiment, canal 10 is disposed between front end 7 and back end 9 and extends from opening 8 towards either top end 3 or bottom end 5.

Where canal 10 meets the opening in first side 11 and/or second side 13, a canal edge 15 is formed. Canal edge 15 defines the opening in first side 11 and/or second side 13. The diameter of this canal edge opening is smaller than the diameter of canal 10. Since the ends of canal 10 have a narrower opening than the inside portion of canal 10, a security cable 16 having a cable end 17 that is larger in diameter than the portion of the security cable 16 that directly precedes it may be secured to lock 2. This configuration allows cable end 17 to travel through the middle portion of canal 10, while still preventing cable end 17 from passing through first side 11 or second side 13 of canal 10 and being removed from lock 2.

In operation, security cable 16 and cable end 17 are passed through opening 8 and received in canal 10, with security cable 16 extending out through either first side 11 or second side 13, while cable end 17 remains within lock 2. Peripheral cables (not shown) may also be passed through opening 8 into canal 10, while extending out through both first side 11 and second side 13. Next, lock 2 is moved towards ring 12 on computer chassis 14. Lower portion 19 of front side 7 may comprise a substantially concave outer surface in order to accommodate the curve in computer chassis 14. As lock 2 is moved towards computer chassis 14, ring 12 is placed in opening 8. As seen in FIG. 2, once ring 12 is lined up with locking pin 6, lock cylinder 4 is engaged (such as by the user pushing the push-button), causing locking pin 6, which is connected to locking cylinder 4, to pass down through opening 8 and ring 12. When locking cylinder 4 is engaged, locking pin 6 engages ring 12, and along with ring 12 and computer chassis 14, blocks opening 8, thereby securing lock 2 and any peripheral cables to ring 12 and computer chassis 14. Since the opening in first side 11 and second side 13 are smaller in diameter than cable end 17 and opening 8 is blocked, cable end 17 is prevented from being removed from lock 2. Security cable 16 may then be attached to a stable object, such as a desk, thereby anchoring computer chassis 14 and protecting the computer from theft. Lock 2 is preferably configured such that the engagement of lock cylinder 4 prevents cable end 17 from being removed even when lock 2 is not attached to ring 12. This feature is achieved by configuring opening 8, canal 10, and the openings in first side 11 and second side 13 such that there is no path large enough for cable end 17 to exit when locking pin 6 comes down and blocks opening 8.

In a preferred embodiment, the body of lock 2 is substantially cylindrical in shape. Additionally, a chamfer 22 may be formed along the perimeter of top end 3 and/or bottom end 5. However, it is contemplated that the body of lock 2, along with its components, may be formed in a variety of shapes and sizes in accordance with the present invention. In an exemplary embodiment, the outer diameter of the body of lock 2 is about 20 mm, the height of lock 2 is about 34 mm, the diameter of canal 10 is about 8.2 mm, the opening in first side 11 and second side 13 is about 6.2 mm in diameter, and canal 10 extends at least about 7.3 mm down away from its connection with opening 8. These dimensions represent one embodiment of the present invention. It is contemplated that a variety of other measurements may be used as well. Preferably, any adjustments will be made proportional to the dimensions provided.

The present invention provides a complete physical security solution for computers. This device locks onto the hasp of a computer chassis, locks the computer's peripheral cables against theft and also anchors the entire computer system down to a desk or other stable object using a security cable. The present invention can be used in conjunction with a number of different adapters, cables and computer chassis, thereby providing universal compatibility.

Although the lock of the present invention has been shown in use with a computer, it is contemplated that it may be used for protecting many other types of equipment against theft as well.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A computer lock comprising:
a body having a top end, a bottom end opposite said top end, a front side, a back side opposite said front side, a first side adjacent to said front side, and a second side opposite said first side;
an opening formed in said front side of said body between said top end and said bottom end, said opening extending from said front side and terminating at a position preceding said back end;
a canal formed in said body and connected to said opening, said canal extending from an opening on said first side to an opening on said second side, wherein a cable may be passed through said opening in said front side and into said canal, and said opening on said first side and said opening on said second side are both narrower than said canal; and
a push-button locking cylinder disposed in said body, said locking cylinder comprising a pin that blocks said opening in said front side when said locking cylinder is engaged and leaves said opening in said front side unobstructed when said locking cylinder is disengaged.

2. The computer lock of claim 1, wherein said push-button locking cylinder is disposed between said top end and said opening in said front side.

3. The computer lock of claim 2, wherein said canal extends from said opening in said front side down towards said bottom end.

4. The computer lock of claim 3, wherein said canal is disposed between said front end and said back end.

5. The computer lock of claim 1, wherein said push-button locking cylinder is disposed closer to said front side than to said back side.

6. The computer lock of claim 1, wherein said body is substantially cylindrical.

7. The computer lock of claim 1, wherein said body comprises a lower portion formed between said bottom end and said opening in said front side, said lower portion being substantially concave on said front side.

8. The computer lock of claim 1, wherein a portion of said push-button locking cylinder connected to said locking pin extends out from said top end when said locking cylinder is disengaged such that said portion is accessible to a user.

9. The computer lock of claim 1, wherein the portion of said body between said bottom end and said opening in said front end forms a lower portion, said front side of said lower portion forming a lip adjacent to said opening in said front end.

10. The computer lock of claim 9, wherein the uppermost surface of said lip comprises an indentation aligned with and configured to receive said locking pin.
